(19) United States
(12) Patent Application Publication
(10) Pub. No.: US 2022/0012873 A1
(43) Pub. Date: Jan. 13, 2022

(54) Predicting Embryo Implantation Probability

(71) Applicant: Embryonics LTD, Bet Shemesh (IL)

(72) Inventors: David H. Silver, Haifa (IL); Yael Gold-Zamir, Bet Shemesh (IL); Alex Bronstein, Haifa (IL); Martin Feder, Netanya (IL)

(21) Appl. No.: 16/926,011

(22) Filed: Jul. 10, 2020

(51) Int. Cl. G06T 7/00; G06N 3/04

(52) U.S. Cl. CPC G06T 7/0012; G06T 2207/10016; G06T 2207/30044; G06N 3/04

(57) ABSTRACT

The present invention extends to methods, systems, and computer program products for predicting embryo implantation probability. A neural network accesses a set of images depicting an embryo. The neural network determines a correlation between the set of images and images corresponding to other embryos considered during neural network training. The neural network derives an embryo implantation probability associated with the embryo based on known implantation outcomes associated with the other embryos and in view of clinical data associated with a potential recipient of the embryo. An embryo is selected for the potential recipient based at least in part on the derived embryo implantation probability. The neural network can also derive a confidence and/or explanation of why the neural network assigned an embryo implantation probability to an embryo. The confidence can be considered in embryo selection.

### TECHNICAL FIELD

The present disclosure relates generally to predicting embryo implantation probability in humans. Aspects include a data-driven system trained to predict embryo implantation probability from a set of embryo images (e.g., embryogenesis time-lapse imaging videos).

### BACKGROUND

The process of fertilizing a human egg outside the body to create an embryo is known as in vitro fertilization (IVF). An embryo created outside the body can then be transferred to a female human, with the desired outcome being pregnancy. IVF is a common technique used to help those suffering from infertility to conceive. IVF is highly effective relative to other assisted reproductive technology (ART) techniques.

As part of an IVF process, multiple embryos are typically created. Among multiple created embryos, some embryos may exhibit characteristics more likely to lead to pregnancy and other embryos may exhibit characteristics less likely to lead to pregnancy. Prior to transfer, trained personnel can select “the best” embryo, from among the multiple embryos for transfer. Embryo selection is typically a highly manual process that lacks any universally accepted and standardized criteria.

More specifically, ova (egg cells) can be harvested from an adult female and fertilized by live sperm in vitro. After successful fertilization, the resulting embryos are incubated for several days while a trained embryologist manually tracks their development. The embryologist may use morphological and/or morphokinetic characteristics to generate a grade for each embryo. An embryo grade is indicative of the embryo's viability and likelihood of successful uterine implantation, and hopefully live birth. Embryos with higher grades can be selected over embryos with lower grades for transfer to a patient.

### BRIEF DESCRIPTION OF THE DRAWINGS

The specific features, aspects and advantages of the present invention will become better understood with regard to the following description and accompanying drawings where:

FIGS. 1A and 1B illustrate an example computer architecture that facilitates predicting embryo implantation probability.

FIG. 2 illustrates a flow chart of an example method for predicting embryo implantation probability

FIG. 3 illustrates another example computer architecture that facilitates predicting embryo implantation probability.

FIG. 4 illustrates an example neural network architecture that facilitates predicting embryo implantation probability.

FIG. 5 illustrates another example neural network architecture that facilitates predicting embryo implantation probability.

FIG. 6 illustrates a further example neural network architecture that facilitates predicting embryo implantation probability.

FIG. 7 illustrates an example block diagram of a computing device.

### DETAILED DESCRIPTION

The present invention extends to methods, systems, and computer program products for predicting embryo implantation probability in humans. Aspects include a data-driven system trained to predict embryo implantation probability from a set of embryo images (e.g., embryogenesis time-lapse imaging videos).

Manual morphological annotation and quality assessment of embryos fertilized in vitro is often used for predicting in vitro fertilization (IVF) success. However, manual assessment can be highly variable between observers. As such, human subjectivity is introduced into the embryo grading and selection process.

Various manual techniques can be used to grade the quality of a blastocyst. These grading techniques can consider blastocyst characteristics and/or parameters. For example, the Gardner method considers shape and dynamics of a blastocyst, inner cell mass, and trophectoderm shape. At least some embryologists may also consider fragmentation and/or reverse cleavage. A human embryologist can use these manual techniques to grade embryos, for example, as “low”, “medium”, or “high”

Other IVF success prediction approaches having become increasing computational. For example, some embryo outcome prediction algorithms execute a series of user-defined tasks on user-defined input parameters (e.g., specific morphological characteristics) to estimate a probability of achieving a user-defined outcome. Thus, these other IVF success prediction approaches essentially attempt to mimic a human embryologist. Automating human embryologist decisions can beneficially increase the efficiency of embryo quality assessment. However, these embryo outcome prediction algorithms depend heavily on scoring characteristics/parameters used for manual assessment. As such, outcome improvement relative to manual assessment (or any increase in effectiveness of embryo quality assessment) is limited at best.

Accordingly, aspects of the invention include a machine learning algorithm that utilizes time-lapse images of embryos as input and trains a neural network to predict embryo implantation probability. Using the trained neural network to predict embryo implantation probably increases the effectiveness of embryo quality assessment relative to manual assessment and corresponding automated approaches. The machine learning algorithm can train a neural network from time-lapse images of embryos along with labels indicative of outcome (e.g., successful implantation or failed implantation). Time-lapse images associated with hundreds or even thousands of transferred embryos having known implantation data (KID) can be used to train the neural network.

A set of time-lapse images corresponding to a newly considered embryo can be supplied to the trained neural network as input. The neural network can predict an implantation probability for the embryo. The neural network essentially determines correlation between the set of time-lapse images and time-lapse images corresponding to other embryos considered during initial or subsequent training. The neural network then derives an implantation probability based on outcomes associated with the training embryos. The neural network can also indicate a confidence associated with the predicted implantation probability.

In one aspect, an implantation probability grade is used to represent implantation probability. For example, a trained neural network can assign embryos an implantation probability grade in a range from 1-5. A larger number indicates a higher probability of implantation and a lower number indicates a lower probability of implantation. However, other ranges and/or grading mechanisms can also be used. In one aspect, a lower number indicates a higher probability of implantation and a higher number indicates a lower probability of implantation.

A neural network can be trained to consider a variety of embryo quality assessment techniques including techniques that consider shape, dynamics, inner cell mass, trophectoderm shape, fragmentation, reverse cleavage, etc. A neural network can also be trained to consider characteristics of a human female recipient, such as, age, body mass index (BMI), medical conditions, etc. A neural network can also be trained to consider time series data, such as, biochemical measurements, ambient conditions, etc. Considering host characteristics and/or time series data along with embryo quality increases accuracy of implantation probabilities relative to considering embryo quality alone.

In general, embryologists do not transfer poor embryos (e.g., embryos graded as “low” or “1”) into a host (i.e., a human female). As such, there can be a lack of ground truth data for poor embryos. Some techniques attempt to overcome this lack of ground truth data by automatically assigning “fail” ground truth to low grade embryos. However, automatic assignment of “fail” ground truth contaminates ground truth with human guesses reducing accuracy. Aspects of the invention instead use data augmentations on ground truth videos to overcome lack of ground truth data.

Some automated techniques use area under the curve (AUC) to determine outcome. Aspects of the invention can (also) measure positive predictive value (PPV) and negative predictive value (NPV). PPV and NPV more directly correlate to improvement in selecting an appropriate embryo or avoiding false transfer, resembling embryologist activities.

Aspects of the invention can use image (e.g., video) dynamics as model input allowing a neural network to learn embryo morphological features as well as morpho kinetics. A neural network can also be elastic to input types. As such, other inputs in addition to images (e.g., clinical data, such as, patient age, patient BMI, patient medical conditions, etc. and/or time series data, such as, biochemical measurements, ambient conditions, etc.) can be included in model training data.

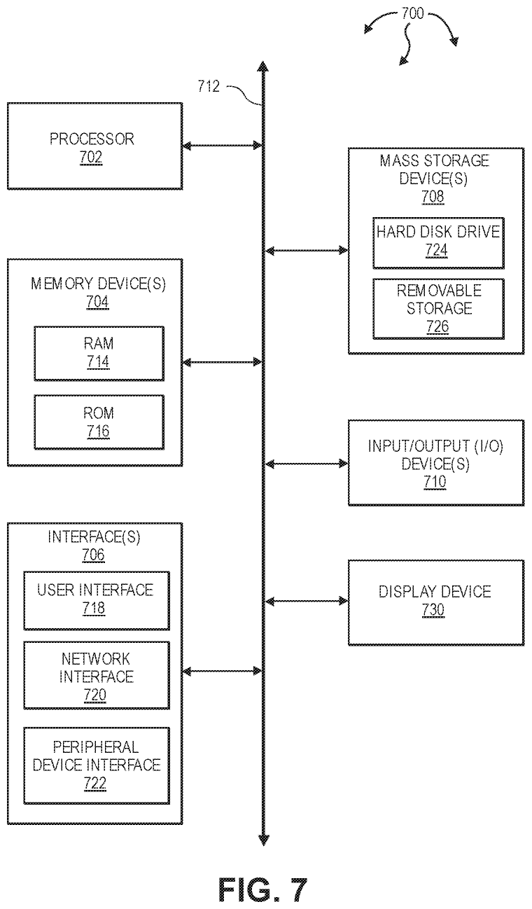

Turning initially to FIG. 7, FIG. 7 illustrates an example block diagram of a computing device 700. Computing device 700 can be used to perform various procedures, such as those discussed herein. Computing device 700 can function as a server, a client, or any other computing entity. Computing device 700 can perform various communication and data transfer functions as described herein and can execute one or more application programs, such as the application programs described herein. Computing device 700 can be any of a wide variety of computing devices, such as a mobile telephone or other mobile device, a desktop computer, a notebook computer, a server computer, a handheld computer, tablet computer and the like.

Computing device 700 includes one or more processor(s) 702, one or more memory device(s) 704, one or more interface(s) 706, one or more mass storage device(s) 708, one or more Input/Output (I/O) device(s) 710, and a display device 730 all of which are coupled to a bus 712. Processor(s) 702 include one or more processors or controllers that execute instructions stored in memory device(s) 704 and/or mass storage device(s) 708. Processor(s) 702 may also include various types of computer storage media, such as cache memory.

Memory device(s) 704 include various computer storage media, such as volatile memory (e.g., random access memory (RAM) 714) and/or nonvolatile memory (e.g., read-only memory (ROM) 716). Memory device(s) 704 may also include rewritable ROM, such as Flash memory.

Mass storage device(s) 708 include various computer storage media, such as magnetic tapes, magnetic disks, optical disks, solid state memory (e.g., Flash memory), and so forth. As depicted in FIG. 7, a particular mass storage device is a hard disk drive 724. Various drives may also be included in mass storage device(s) 108 to enable reading from and/or writing to the various computer readable media. Mass storage device(s) 708 include removable media 726 and/or non-removable media.

I/O device(s) 710 include various devices that allow data and/or other information to be input to or retrieved from computing device 700. Example I/O device(s) 710 include cursor control devices, keyboards, keypads, barcode scanners, microphones, monitors or other display devices, speakers, printers, network interface cards, modems, cameras, lenses, radars, CCDs or other image capture devices, and the like.

Display device 730 includes any type of device capable of displaying information to one or more users of computing device 700. Examples of display device 730 include a monitor, display terminal, video projection device, and the like.

Interface(s) 706 include various interfaces that allow computing device 700 to interact with other systems, devices, or computing environments as well as humans. Example interface(s) 706 can include any number of different network interfaces 720, such as interfaces to personal area networks (PANs), local area networks (LANs), wide area networks (WANs), wireless networks (e.g., near field communication (NFC), Bluetooth, Wi-Fi, etc., networks), and the Internet. Other interfaces include user interface 718 and peripheral device interface 722.

Bus 712 allows processor(s) 702, memory device(s) 704, interface(s) 706, mass storage device(s) 708, and I/O device(s) 710 to communicate with one another, as well as other devices or components coupled to bus 712. Bus 712 represents one or more of several types of bus structures, such as a system bus, PCI bus, IEEE 1394 bus, USB bus, and so forth.

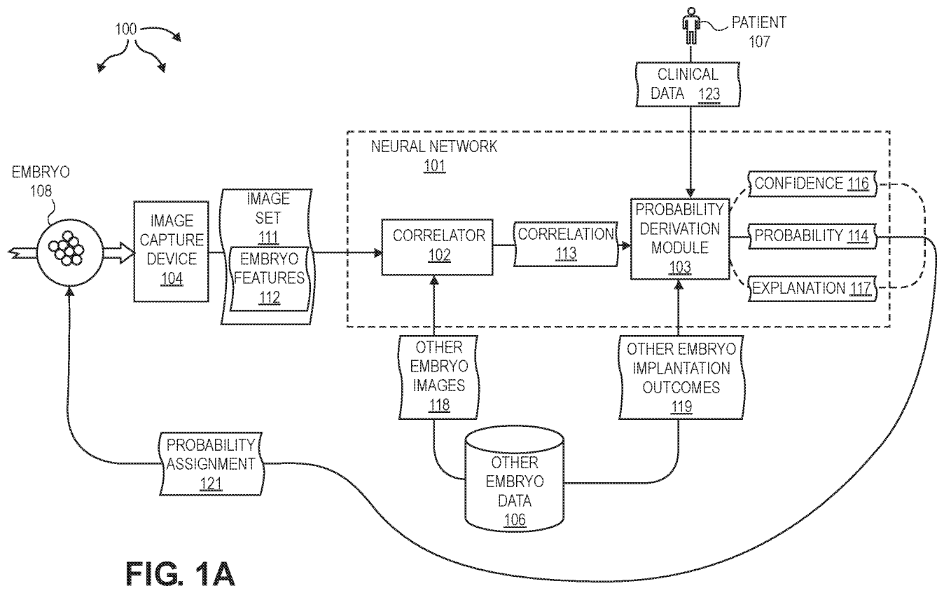

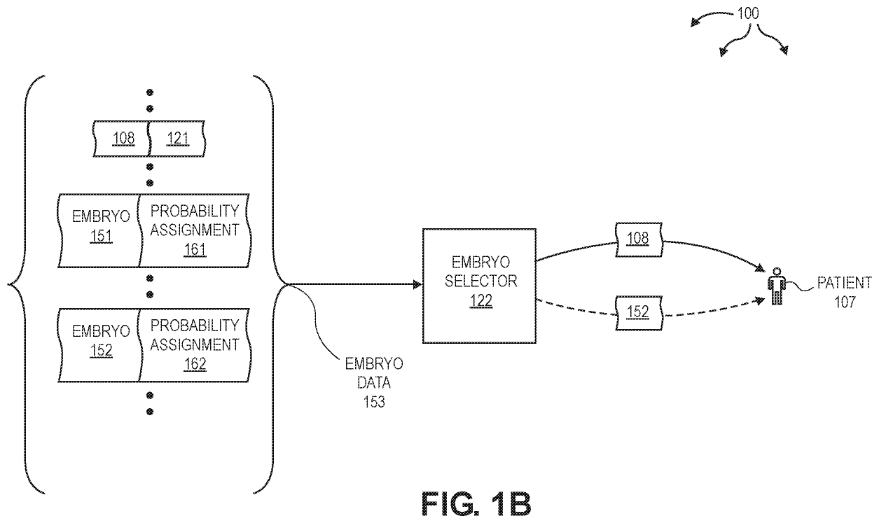

Returning to FIGS. 1A and 1B, FIGS. 1A and 1B illustrate an example computer architecture 100 that facilitates predicting embryo implantation probability. As depicted, computer architecture 100 includes neural network 101, image capture device 104, and other embryo data 106. Neural network 101 includes correlator 102 and probability derivation module 103.

Image capture device 104 can include a camera for capturing still images and/or capturing video. Image capture device 104 can be included in another device or apparatus, such as, for example, in a microscope. Image capture device 104 can be configured and/or positioned to capture images and/or video of embryos. In one aspect, image capture device 104 captures a set of images depicting an embryo. The set of images can be a set of time-lapse images. The set of images can (e.g., collectively) depict morphological features of an embryo and/or morpho kinetics of the embryo.

Other embryo data 106 can store images of other embryos along with corresponding implantation outcomes associated with each of the other embryos. Implantation outcomes can include implantation success, implantation failure, reasons for implantation failure, etc.

In general, neural network 101 can access a set of images of an embryo and derive an embryo implantation probability (i.e., a probability of the embryo successfully implanting in a potential recipient). More specifically, correlator 102 can correlate images of an embryo with images of other embryos. For example, correlator 102 can identify other embryos having features similar to the embryo. Probability derivation module 103 can consider the correlation along with clinical data (for the potential recipient) in view of implantation outcomes associated with the other correlated (or similar) embryos.

Probability derivation module 103 can compute a probability of the embryo successfully implanting in the potential recipient. The probability can include a positive predictive value (PPV) and/or negative predictive value (NPV). Probability derivation module 103 can also compute a confidence associated with the probability and an explanation of how the probability was computed. Probability, along with a confidence and an explanation when appropriate, can be assigned to the embryo.

The process can be repeated for other embryos. Based on probabilities (and possibly confidences), embryos can be ranked relative to one another. An embryo (or embryos) with higher probability (or probabilities) of implantation can be selected for implantation into potential recipient (e.g., a human female).

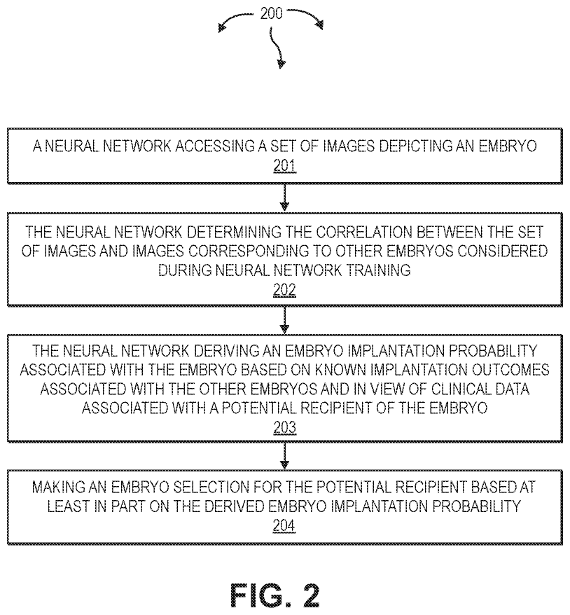

FIG. 2 illustrates a flow chart of an example method 200 for predicting embryo implantation probability. Method 200 will be described with respect to the components and data in computer architecture 100.

Image capture device 104 can capture image set 111, including embryo features 112, of (human) embryo 108. In one aspect, image set 111 can be a set of time-lapse images. Embryo features 112 can include morphological features of embryo 108 and/or morpho kinetics of embryo 108.

Method 200 includes a neural network accessing a set of images depicting an embryo (201). For example, neural network 101, and more specifically correlator 102, can access image set 111.

Method 200 includes the neural network determining a correlation between the set of images and images corresponding to other embryos considered during neural network training (202). For example, correlator 102 can access other embryo images 118 (previously used as training data for neural network 101) from other embryo data 106. Correlator 102 can determine correlation 113 between image set 111 and other embryo images 118. Correlator 102 can send correlation 113 to probability derivation module 103.

Method 200 includes the neural network deriving an embryo implantation probability associated with the embryo based on known implantation outcomes associated with the other embryos and in view of clinical data associated with a potential recipient of the embryo (203). For example, probability derivation module 103 can receive correlation 113 from correlator 102. Probability derivation module 103 can access clinical data associated with patient 107 and can access other embryo implantation outcomes 119 from other embryo data 106. Based at least on correlation 113, clinical data 123, and other embryo implantation outcomes 119, probability derivation module 103 can derive probability 114. Probability 114 can include a positive predictive value (PPV) and/or negative predictive value (NPV).

Based at least on correlation 113, clinical data 123, and other embryo implantation outcomes 119, probability derivation module 103 can also derive confidence 116 (e.g., confidence level and interval) and explanation 117. Explanation 117 can explain why neural network 101 derived probability 114 for embryo 108.

Neural network 100 can combined probability 114, confidence 116, and explanation 117 into probability assignment 121. Neural network 101 can assign probability assignment 121 to embryo 108. Turning to FIG. 1B, acts 201, 202, and 203 can be repeated for embryos 151, 152, etc. Neural network 101 can assign probability assignments 161 (including probability 171), 162 (including probability 172), etc. to embryos 151, 152, etc. respectively. An indication of embryos and corresponding probability assignments can be stored in embryo data 153.

Method 200 includes making an embryo selection for the potential recipient based at least in part on the derived embryo implantation probability (204). For example, embryo selector 122 can consider embryo data 153. From embryo data 153, embryo selector 122 can select an embryo (or embryos) from attempted implantation into patient 107.

It may be that probability 114 indicates a higher probability of successful implantation relative to probabilities 171, 172, and probabilities associated with other embryos in embryo data 153. That is, probability 114 is higher than probabilities associated embryos 171, 172, etc. As such, based on probability 114 (and possibly confidence 116), embryo selector 122 can select embryo 108 for implantation into patient 107.

On the other hand, it may be that probability 172 indicates a higher probability of successful implantation relative to probabilities 114, 171, and probabilities associated with other embryos in embryo data 153. That is, probability 172 is higher than probabilities associated embryos 114, 172, etc. As such, based on probability 172 (and possibly a corresponding confidence), embryo selector 122 can select embryo 152 for implantation into patient 107.

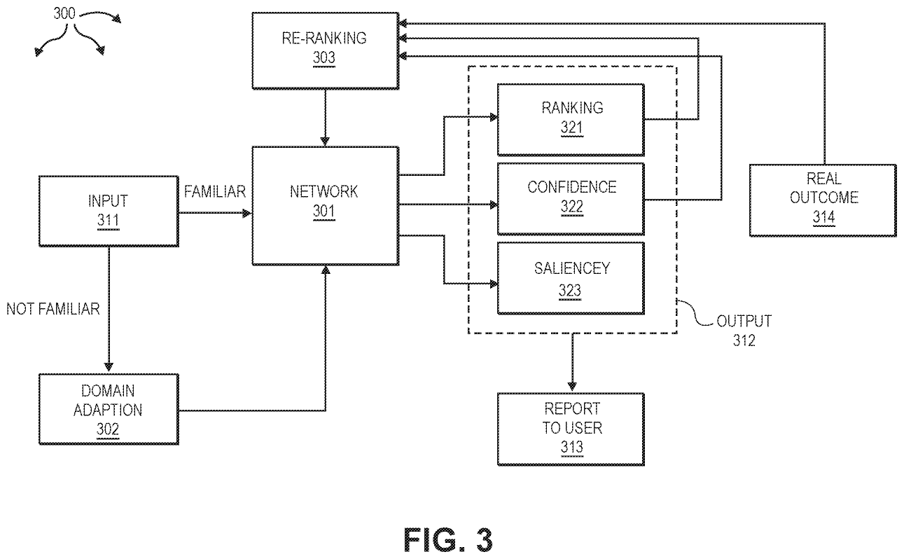

FIG. 3 illustrates computer architecture 300 that facilitates predicting embryo implantation probability. As depicted, computer architecture 300 includes network 301 (e.g., a neural network), domain adaptation 302, and re-ranking 303. Input 311 can be an embryo image set (e.g., a time series set of embryo images). When input 311 is unfamiliar to network 301, input 311 can be sent to domain adaption 302. Input 311 may be unfamiliar due to different parameters, parameter types, etc. Domain adaption 302 can update network 301 to handle the unfamiliar data. As such, domain adaption 302 can essentially cause unfamiliar data to become familiar to network 301.

When input 311 is familiar to network 301, network 301 can derive output 312 from input 311. Output 312 can include (embryo) ranking 321, confidence 322 (a confidence in ranking 321), and saliency 323 or other explanatory maps. Report to user 313 can be generated from output 312. The report can be sent to a potential recipient (patient).

When embryo implantation is attempted in a patient, real outcome 314 can be monitored and recorded. Real outcome 314 can indicate implantation success, implantation failure, reasons for implantation failure, etc. Ranking 321, confidence 322, and real outcome 314, can be used by re-ranking 303 to (re)rank available embryos. For example, a newly ranked embryo may be ranked higher and/or lower than other previously ranked embryos. A list of embryos can be re-ranked to indicate the position of the newly ranked embryo relative to previously ranked embryos.

Alternately, when an embryo implantation attempt is performed, remaining embryos can be re-ranked relative to one another based on the implantation outcome. (Re)Ranked embryos can be used as input to network 301. As such, embryo rankings and implantation outcomes can be used as feedback to network 301. Based on the feedback, network 301 can be refined.

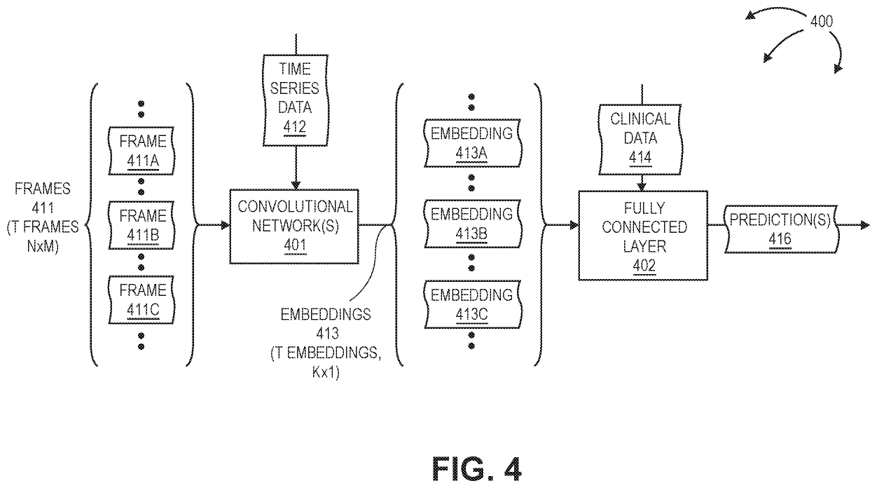

FIG. 4 illustrates neural network architecture 400 that facilitates predicting embryo implantation probability. The components depicted in neural network architecture 400 can included in neural network 101 and/or of network 301. Neural network 400 uses an embedding route to derive embryo implantation predictions.

Convolutional network(s) 401 can receive frames 411 and time series data 412. Frames 411 can include T (image) frames of size N×M including frames 411A, 411B, 411C, etc. Time series data 412 can include biochemical measurements, ambient conditions, etc. Convolutional network(s) 401 can convert each N×M frame to a K×1 vector using a low dimensional embedding (i.e., K<N×M). Vector conversion can be done with convolutional layers using an encoder pretrained as an autoencoder. Convolutional network(s) 401 can add any time series information 412 to get a collection of T×(K+L) embeddings, where L is the number of additional numbers from time series information 412. Convolutional network(s) 401 can also consider global parameters (i.e., parameters associated with entire video as opposed to an individual frame) during vector conversion.

T*(K+L)+G can be concatenated into a sufficiently dense fully connected layer. P embryo implantation predictions can be made on a set of images (e.g., a video) as a whole. The fully connected layer can also derive frame specific predictions on single frame K+L+G parameters, such as, for example, number of cells in a frame.

In one aspect, convolutional network(s) 401 output embeddings 413, including embeddings 413A, 413B, 413C, etc. Convolutional network(s) 401 can send embeddings 413 to fully connected layer 402. Fully connected layer 402 can receive embeddings 413 from convolutional network(s) 401 and can also access clinical data 414. Based on embeddings 413 and clinical data 414, fully connected layer 402 can derive embryo implantation prediction(s) 416.

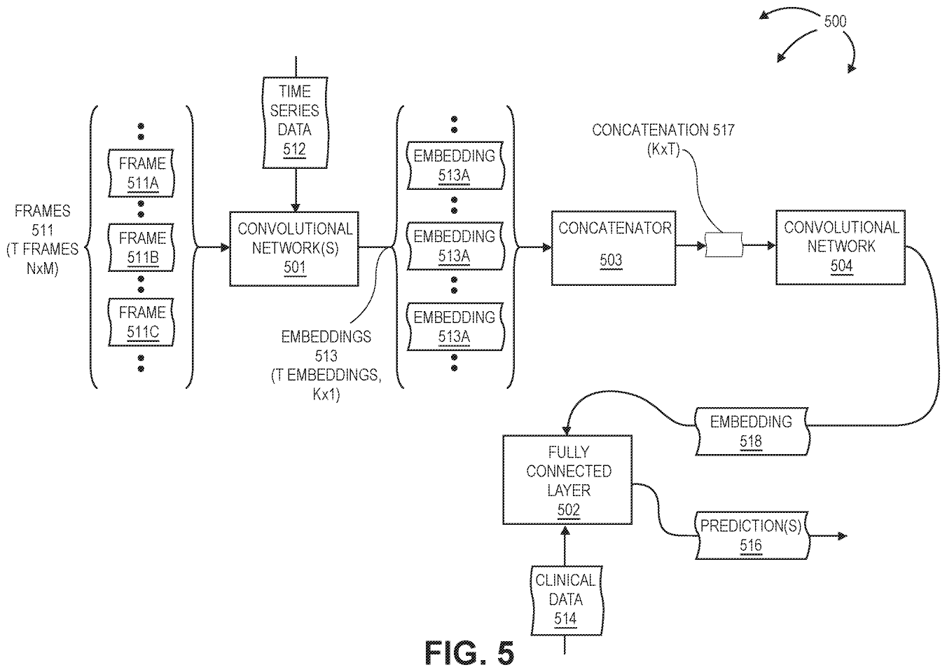

FIG. 5 illustrates neural network architecture 500 that facilitates predicting embryo implantation probability. The components depicted in neural network architecture 500 can included in neural network 101 and/or of network 301. Neural network 500 uses a linear time route to derive embryo implantation predictions.

Convolutional network(s) 501 can receive frames 511 and time series data 512. Frames 511 can include T (image) frames of size N×M including frames 511A, 511B, 511C, etc. Time series data 512 can include biochemical measurements, ambient conditions, etc. Convolutional network(s) 501 can convert each N×M frame to a K×1 vector using a low dimensional embedding (i.e., K<N×M). Vector conversion can be done with convolutional layers using an encoder pretrained as an autoencoder. Convolutional network(s) 501 can add any time series information 512 to get a collection of T×(K+L) embeddings, where L is the number of additional numbers from time series information 512. Convolutional network(s) 501 can also consider global parameters (i.e., parameters associated with entire video as opposed to an individual frame) during vector conversion.

In one aspect, convolutional network(s) 501 output embeddings 513, including embeddings 513A, 513B, 513C, etc. Convolutional network(s) 501 can send embeddings 513 to concatenator 503. Concatenator 503 can receive embeddings 513 from convolutional network(s) 501. Concatenator 503 can concatenate embeddings 513 into concatenation 517 (e.g., a matrix of size T×(K+L)). Concatenator 503 can send concatenation 517 to convolutional network 504.

Convolutional network 504 can receive concatenation 517 from concatenator 503. Convolutional network 504 can perform 1D convolutions on concatenation 517. The convolutions can mix on the temporal dimension T. Convolutions can be performed until an output layer is sufficiently dense.

In one aspect, convolutional network 504 outputs embedding 518 (e.g., an R×1 video embedding). Convolutional network 504 can send embedding 518 to fully connected layer 502. Fully connected layer 502 can receive embedding 518 from convolutional network 504 and can also access clinical data 514. Based on embedding 518 and clinical data 514, fully connected layer 502 can derive embryo implantation prediction(s) 516.

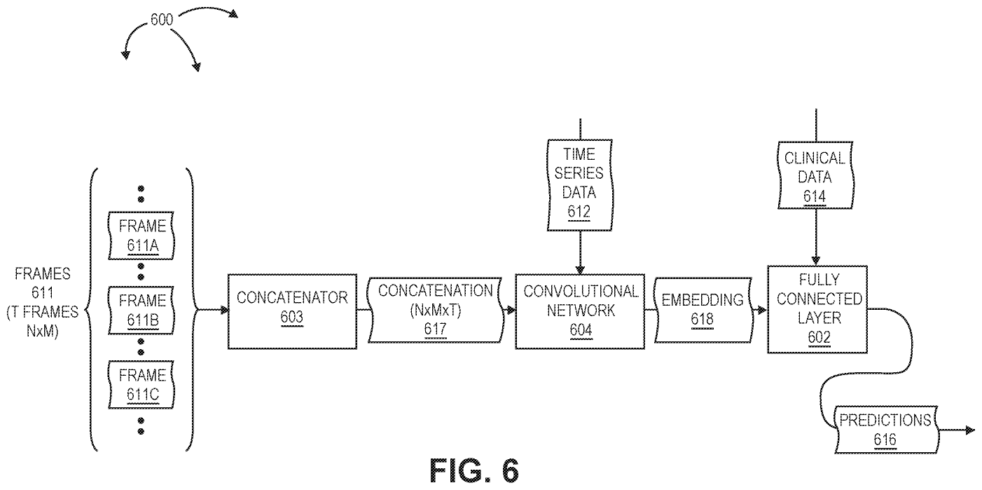

FIG. 6 illustrates neural network architecture 600 that facilitates predicting embryo implantation probability. The components depicted in neural network architecture 600 can included in neural network 101 and/or of network 301. Neural network 600 uses a three-dimensional video route to derive embryo implantation predictions.

Concatenator 603 can receive frames 611. Frames 611 can include T (image) frames of size N×M including frames 611A, 611B, 611C, etc. Concatenator 603 can concatenate frames 611 into concatenation 617 (e.g., a matrix of size N×M×T). Concatenator 603 can send concatenation 617 to convolutional network 604 (a three-dimensional convolutional network).

Convolutional network 504 can receive concatenation 617 from concatenator 603 and can also access time series data 612. Based on concatenation 617 and time series data 612, convolutional network 604 can perform 3D convolutions to generate embedding 618 (e.g., an R×1 video embedding). The convolutions can mix temporal dimension and spatial dimensions. Other relevant information can be injected at appropriate layers. Convolutions can be performed until an output layer is sufficiently dense.

In one aspect, convolutional network 604 outputs embedding 618. Convolutional network 604 can send embedding 618 to fully connected layer 602. Fully connected layer 602 can receive embedding 618 from convolutional network 604 and can also access clinical data 614. Based on embedding 618 and clinical data 614, fully connected layer 602 can derive embryo implantation prediction(s) 616.

In the above disclosure, reference has been made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s).

At least some embodiments of the disclosure have been directed to computer program products comprising such logic (e.g., in the form of software) stored on any computer useable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

1. A method comprising:
a neural network accessing a set of images depicting an embryo;
the neural network determining a correlation between the set of images and images corresponding to other embryos considered during neural network training;
the neural network deriving an embryo implantation probability associated with the embryo based on known implantation outcomes associated with the other embryos and in view of clinical data associated with a potential recipient of the embryo; and
making an embryo selection for the potential recipient based at least in part on the derived embryo implantation probability.

2. The method of claim 1, further comprising computing a confidence associated with the implantation probability.

3. The method of claim 2, wherein making an embryo selection comprises making an embryo selection based at least in part on the confidence.

4. The method of claim 1, wherein making an embryo selection comprises selecting the embryo.

5. The method of claim 1, wherein deriving an embryo implantation probability comprises deriving one or more of: a positive predictive value or a negative predictive value.

6. The method of claim 1, wherein deriving an embryo implantation probability comprises deriving an embryo implantation probability (1) considering morphological features of the embryo and (2) considering morpho kinetics of the embryo.

7. The method of claim 1, wherein receiving a set of images depicting an embryo comprises receiving a set of time-lapse images depicting an embryo.

8. The method of claim 7, wherein determining a correlation between the set of images and images corresponding to other embryos comprises determining a correlation between the set of time-lapse images and time-lapse images corresponding to the other embryos.

9. The method of claim 1, wherein receiving a set of images depicting an embryo comprises receiving a set of microscope captured images depicting an embryo.

10. The method of claim 1, further comprising:
assigning the derived embryo implantation probability to the embryo; and
formulating an explanation of why the neural network assigned the embryo implantation probability to the embryo.

11. The method of claim 1, wherein receiving a set of images depicting an embryo comprises receiving a first image and a second image;
wherein determining a correlation between the set of images and images corresponding to other embryos comprises:
converting the first image to a first vector using an embedding;
converting the second image to a second vector using the embedding;
forming a first time series image by adding first time series information associated with the first image to the first image;
forming a second time series image by adding second time series information associated with the second image to the second image;
accessing clinical parameters associated with the potential recipient of the embryo; and
concatenating the first time series image, the second time series image, and the clinical parameters into a fully connected neural network layer; and
wherein deriving an embryo implantation probability comprises predicting the embryo implantation probability using the fully connected neural network layer.

12. The method of claim 1, wherein receiving a set of images depicting an embryo comprises receiving a first image and a second image;
wherein determining a correlation between the set of images and images corresponding to other embryos comprises:
converting the first image to a first vector using an embedding;
converting the second image to a second vector using the embedding;
forming a first time series image by adding first time series information associated with the first image to the first image;
forming a second time series image by adding second time series information associated with the second image to the second image;
accessing clinical parameters associated with the potential recipient of the embryo; and
concatenating the first time series image, the second time series image, and the clinical parameters into a matrix; and
performing one dimensional convolutions on a temporal dimension of the matrix until an output layer has a threshold density; and
wherein deriving an embryo implantation probability comprises predicting the embryo implantation probability using the output layer of the threshold density.

13. The method of claim 1, wherein receiving a set of images depicting an embryo comprises receiving a first image and a second image;
wherein determining a correlation between the set of images and images corresponding to other embryos comprises performing three dimensional convolutions on the plurality of images, including (a) mixing temporal dimensions and spatial dimensions and (b) injecting clinical parameters associated with the potential recipient of the embryo at appropriate layers, until an output layer has a threshold density; and
wherein deriving an embryo implantation probability comprises predicting a probability of the embryo implanting in the potential recipient using the output layer.

14. A system comprising:
a processor;
system memory coupled to the processor and storing instructions configured to cause the processor to:
receive a set of images depicting an embryo;
determine a correlation between the set of images and images corresponding to other embryos considered during neural network training;
deriving an embryo implantation probability associated with the embryo based on known implantation outcomes associated with the other embryos and in view of clinical data associated with a potential recipient of the embryo and the determined correlation; and
making an embryo selection for the potential recipient based at least in part on the derived embryo implantation probability.

15. The system of claim 14, further comprising instructions configured to compute a confidence associated with the implantation probability; and
wherein instructions configured to make an embryo selection comprise instructions configured to make an embryo selection based at least in part on the confidence and the implantation probability.

16. The system of claim 14, wherein instructions configured to derive an embryo implantation probability comprise instructions configured to derive one or more of: a positive predictive value or a negative predictive value.

17. The system of claim 14, wherein instructions configured to derive an embryo implantation probability comprise instructions configured to derive an embryo implantation probability (1) considering morphological features of the embryo and (2) considering morpho kinetics of the embryo.

18. The system of claim 14, wherein instructions configured to receive a set of images depicting an embryo comprise instructions configured to receive a set of time-lapse images depicting an embryo; and
wherein instructions configured to determine a correlation between the set of images and images corresponding to other embryos comprise instructions configured to determine a correlation between the set of time-lapse images and time-lapse images corresponding to the other embryos.

19. The system of claim 14, further comprising instructions configured to:
assign the derived embryo implantation probability to the embryo; and
formulate an explanation of why the neural network assigned the embryo implantation probability to the embryo.

20. The system of claim 14, wherein instructions configured to receive a set of images depicting an embryo comprise instructions configured to receive a set of microscope captured images depicting an embryo.
